(19) United States
(12) Patent Application Publication
(10) Pub. No.: US 2014/0029506 A1
(43) Pub. Date: Jan. 30, 2014

(54) METHOD AND APPARATUS FOR MINIMIZING INTERFERENCE AT A MOBILE STATION USING A SHARED NODE

(71) Applicants: Onur Sahin, Brooklyn, NY (US); Erdem Bala, Farmingdale, NY (US); Rui Yang, Greenlawn, NY (US)

(72) Inventors: Onur Sahin, Brooklyn, NY (US); Erdem Bala, Farmingdale, NY (US); Rui Yang, Greenlawn, NY (US)

(73) Assignee: INTERDIGITAL PATENT HOLDINGS, INC., Wilmington, DE (US)

(21) Appl. No.: 13/990,761

(22) PCT Filed: Nov. 29, 2011
(86) PCT No.: PCT/US11/62432

§ 371 Date: Oct. 16, 2013

Related U.S. Application Data
(60) Provisional application No. 61/419,163, filed on Dec. 2, 2010.

(51) Int. Cl. H04W 72/08

(52) U.S. Cl. CPC H04W 72/082
USPC 370/315; 370/329; 370/330; 370/336

(57) ABSTRACT

A method and apparatus are described for minimizing inter-cell interference at multiple wireless transmit/receive units (WTRUs) using a shared node (SN). Each WTRU may be configured to receive a desired signal transmitted by a base station in a cell combined with interfering signals transmitted by other base stations in other cells in a first transmission time interval (TTI), and a precoded signal transmitted by the SN in a second TTI. The WTRUs may buffer the desired and interfering mixed signals received in the first TTI, and then combine the buffered signals with the precoded signal received in the second TTI to minimize the interfering signal's power and maximize the desired signal's power at each WTRU so that the desired signal may be decoded with higher probability. The SN may generate the precoded signal based on codewords or codeword components transmitted by the base stations in the same resource blocks.

### CROSS REFERENCE TO RELATED APPLICATIONS

This application claims priority to International Application No. PCT/US2011/062432, filed Nov. 29, 2011, which claims the benefit of U.S. Provisional Application No. 61/419,163 filed Dec. 2, 2010, the contents of which are hereby incorporated by reference herein.

### FIELD OF INVENTION

This application is related to wireless communications.

### BACKGROUND

Wireless communication systems may be prone to interference due to limitations of wireless links. For example, in a cellular system that exhibits a frequency reuse scheme in order to increase the spectral efficiency, the communication rates among the nodes operating in the same frequency band may be degraded due to interference resulting from simultaneous transmission.

To overcome the limitations of wireless links arising from interference, the use of a shared node (SN), (i.e., helper node, relay node), has been implemented to combat limitations in wireless links. However, an SN has not been considered widely to mitigate inter-cell interference.

### SUMMARY

A method and apparatus are described for minimizing inter-cell interference at multiple wireless transmit/receive units (WTRUs) using a shared node (SN). Each WTRU may be configured to receive a desired signal transmitted by a base station in a cell combined with interfering signals transmitted by other base stations in other cells in a first transmission time interval (TTI), and a precoded signal transmitted by the SN in a second TTI. The WTRUs may buffer the desired and interfering mixed signals received in the first TTI, and then combine the buffered signals with the precoded signal received in the second TTI to minimize the interfering signal's power and maximize the desired signal's power at each WTRU so that the desired signal may be decoded with higher probability. The SN may generate the precoded signal based on codewords or codeword components transmitted by the base stations in the same resource blocks. Each WTRU may transmit positive acknowledgement (ACK)/negative acknowledgement (NACK) feedback to its base station based on the results of attempting to decode the codewords or codeword components at the end of second TTI.

### BRIEF DESCRIPTION OF THE DRAWINGS

A more detailed understanding may be had from the following description, given by way of example in conjunction with the accompanying drawings wherein:

FIG. 1A shows an example communications system in which one or more described embodiments may be implemented;

FIG. 1B shows an example wireless transmit/receive unit (WTRU) that may be used within the communications system shown in FIG. 1A;

FIG. 1C shows an example radio access network and an example core network (CN) that may be used within the communications system shown in FIG. 1A;

FIG. 2A shows a first transmission phase of a half-duplex system using a shared node (SN);

FIG. 2B shows a second transmission phase of the half-duplex system of FIG. 2A;

FIG. 3 is a flow diagram of a procedure for processing signals transmitted by base stations (BSs) at the SN and scheduled wireless transmit/receive units (WTRUs) to mitigate inter-cell interference;

FIG. 4 is signal flow diagram of a procedure for processing codewords using an SN;

FIG. 5 is a signal flow diagram of a partial decode-and-forward (DF) shared relaying procedure using an SN;

FIG. 6 shows network architecture using an SN;

FIG. 7 is a signal flow diagram of a procedure for pairing WTRUs and choosing a precoding method;

FIG. 8 shows a system using channel state information (CSI);

FIG. 9 shows an example block diagram of an SN; and

FIG. 10 shows an example block diagram of a WTRU

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment.

When referred to hereafter, the terminology “base station (BS)” includes but is not limited to a Node-B, a site controller, an access point (AP), or any other type of interfacing device capable of operating in a wireless environment.

When referred to hereafter, the terminology “shared node (SN)” refers to a node, (i.e., relay node, helper node, helper WTRU) that forwards at least one signal. In the case of an uplink transmission, the node forwards at least one signal received from at least one WTRU to at least one base station, (e.g., Node-B, access point (AP), evolved Node-B (eNB), and the like). In the case of a downlink transmission, the node forwards at least one signal received from at least one base station to at least one WTRU.

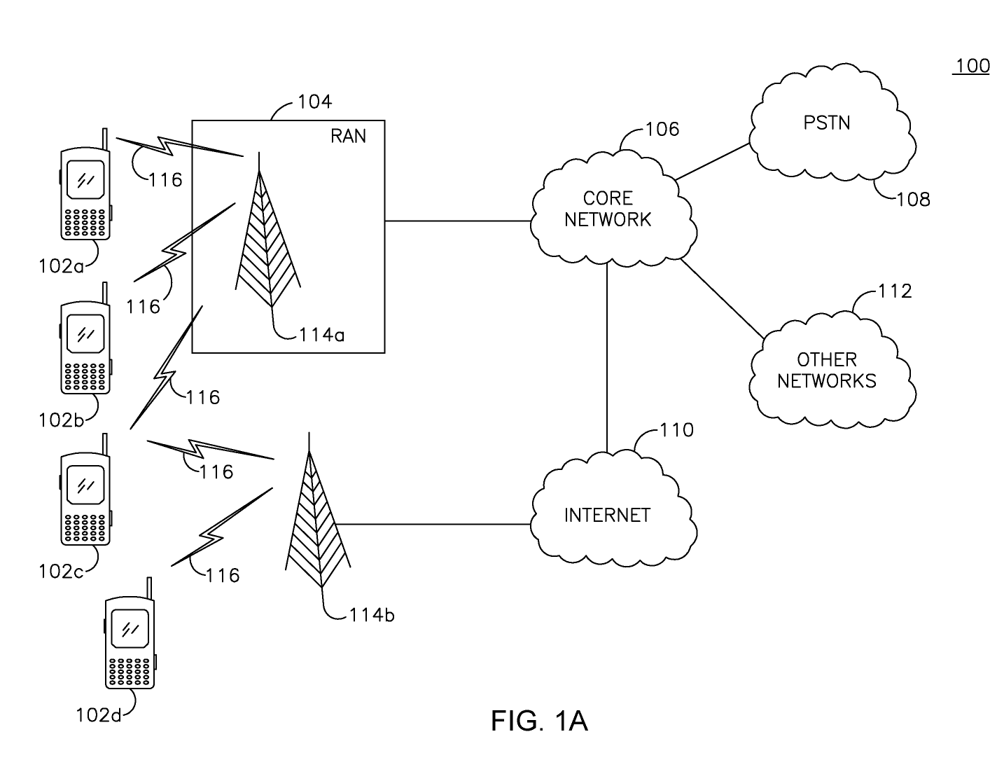

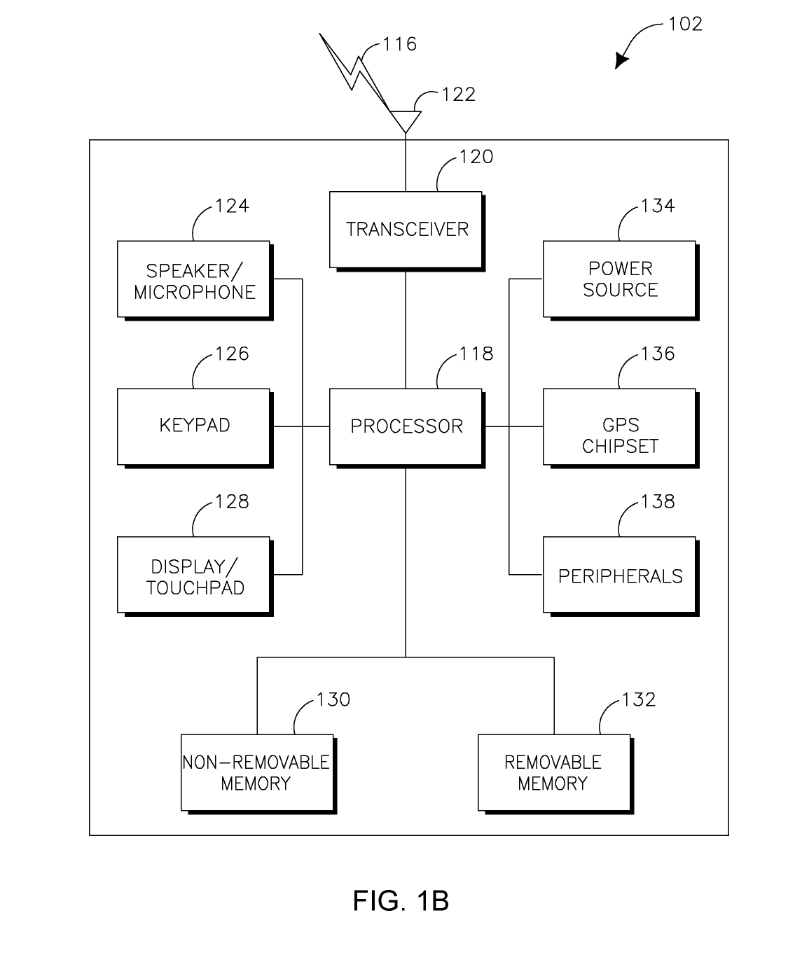

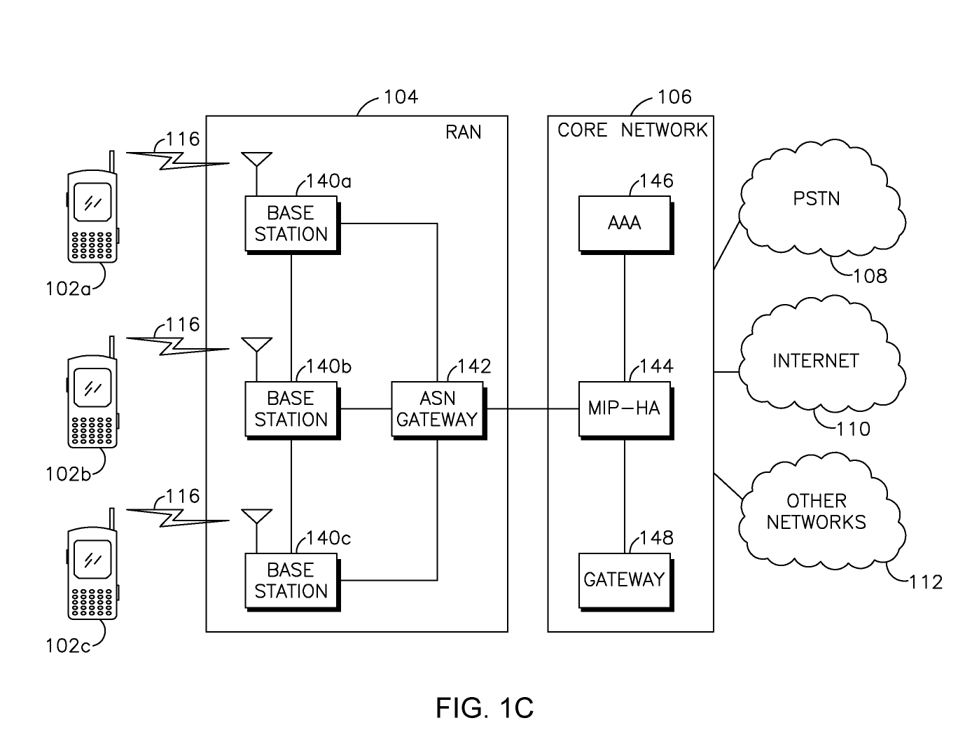

FIG. 1A shows an example communications system 100 in which one or more described embodiments may be implemented. The communications system 100 may be a multiple access system that provides content, such as voice, data, video, messaging, broadcast, and the like, to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include WTRUs 102a, 102b, 102c, 102d, a radio access network (RAN) 104, a core network (CN) 106, a public switched telephone network (PSTN) 108, the Internet 110, and other networks 112, though it will be appreciated that the described embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a notebook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a Node-B, an evolved Node-B (eNB), a Home Node-B (HNB), a Home eNB (HeNB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link, (e.g., radio frequency (RF), microwave, infrared (IR), ultraviolet (UV), visible light, and the like). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as universal mobile telecommunications system (UMTS) terrestrial radio access (UTRA), which may establish the air interface 116 using wideband CDMA (WCDMA). WCDMA may include communication protocols such as high-speed packet access (HSPA) and/or evolved HSPA (HSPA+). HSPA may include high-speed downlink (DL) packet access (HSDPA) and/or high-speed uplink (UL) packet access (HSUPA).

In another embodiment, the base station 114a and the WTRUs 102a, 102b, 102c may implement a radio technology such as evolved UTRA (E-UTRA), which may establish the air interface 116 using long term evolution (LTE) and/or LTE-advanced (LTE-A).

In other embodiments, the base station 114a and the WTRUs 102a, 102b, 102c may implement radio technologies such as IEEE 802.16 (i.e., worldwide interoperability for microwave access (WiMAX)), CDMA2000, CDMA2000 1X, CDMA2000 evolution-data optimized (EV-DO), Interim Standard 2000 (IS-2000), Interim Standard 95 (IS-95), Interim Standard 856 (IS-856), global system for mobile communications (GSM), enhanced data rates for GSM evolution (EDGE), GSM/EDGE RAN (GERAN), and the like.

The base station 114b in FIG. 1A may be a wireless router, HNB, HeNB, or AP, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT, (e.g., WCDMA, CDMA2000, GSM, LTE, LTE-A, and the like), to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over Internet protocol (VoIP) services to one or more of the WTRUs 102a, 102b, 102c, 102d. For example, the CN 106 may provide call control, billing services, mobile location-based services, pre-paid calling, Internet connectivity, video distribution, and the like, and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing an E-UTRA radio technology, the CN 106 may also be in communication with another RAN (not shown) employing a GSM radio technology.

The CN 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the Internet protocol (IP) in the TCP/IP suite. The networks 112 may include wired or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B shows an example WTRU 102 that may be used within the communications system 100 shown in FIG. 1A. As shown in FIG. 1B, the WTRU 102 may include a processor 118, a transceiver 120, a transmit/receive element, (e.g., an antenna), 122, a speaker/microphone 124, a keypad 126, a display/touchpad 128, a non-removable memory 130, a removable memory 132, a power source 134, a global positioning system (GPS) chipset 136, and peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a microprocessor, one or more microprocessors in association with a DSP core, a controller, a microcontroller, an application specific integrated circuit (ASIC), a field programmable gate array (FPGA) circuit, an integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. The transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122, (e.g., multiple antennas), for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station, (e.g., base stations 114a, 114b), and/or determine its location based on the timing of the signals being received from two or more nearby base stations. The WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C shows an example RAN 104 and an example CN 106 that may be used within the communications system 100 shown in FIG. 1A. As noted above, the RAN 104 may employ an E-UTRA radio technology to communicate with the WTRUs 102a, 102b, 102c over the air interface 116. The RAN 104 may also be in communication with the CN 106.

The RAN 104 may include eNBs 140a, 140b, 140c, though it will be appreciated that the RAN 104 may include any number of eNBs while remaining consistent with an embodiment. The eNBs 140a, 140b, 140c may each include one or more transceivers for communicating with the WTRUs 102a, 102b, 102c over the air interface 116. In one embodiment, the eNBs 140a, 140b, 140c may implement MIMO technology. Thus, the eNB 140a, for example, may use multiple antennas to transmit wireless signals to, and receive wireless signals from, the WTRU 102a.

Each of the eNBs 140a, 140b, 140c may be associated with a particular cell (not shown) and may be configured to handle radio resource management decisions, handover decisions, scheduling of users in the UL and/or DL, and the like. As shown in FIG. 1C, the eNBs 140a, 140b, 140c may communicate with one another over an X2 interface.

The CN 106 shown in FIG. 1C may include a mobility management entity (MME) 142, a serving gateway 144, and a packet data network (PDN) gateway (GW) 146. While each of the foregoing elements is depicted as part of the CN 106, it will be appreciated that any one of these elements may be owned and/or operated by an entity other than the CN operator.

The MME 142 may be connected to each of the eNBs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNBs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNB handovers, triggering paging when DL data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway, (e.g., an IP multimedia subsystem (IMS) server), that serves as an interface between the CN 106 and the PSTN 108. In addition, the CN 106 may provide the WTRUs 102a, 102b, 102c with access to other networks 112, which may include other wired or wireless networks that are owned and/or operated by other service providers.

Relaying operations may be implemented where an SN with multiple antennas communicates with one or more base stations that may interfere with each other. By using various precoding schemes, an SN may assist WTRUs by forwarding a desired signal and mitigating existing inter-cell interference. In one TTI, base stations may transmit signals to their respective WTRUs, and the SN is able to monitor and decode at least a portion of their transmissions. Then, in the next TTI, the SN may design its relaying operation, (i.e., precoder selection), and the like, such that the interfered WTRU maybe able to mitigate the interference and decode its packet.

In one embodiment, a half-duplex decode-and-forward (DF) SN may jointly decode a plurality of signals received from interfering base stations simultaneously, (i.e., same time/frequency resource block), and in a later time slot may transmit with an optimized precoding matrix which resolves the interference at the WTRUs and facilitates decoding. The optimization may depend on the overall channel state information (CSI) in the system, based on the direct and interfering links between the base stations and the WTRUs, as well as the links between the SN and the WTRUs.

In another embodiment, an interference-alignment SN may employ a precoding operation such that, after proper combining of the signals received at different time slots at the WTRUs, the desired and interfering signals may lay in orthogonal subspaces with respect to each other.

In another embodiment using a partial DF SN, the interfering base stations may transmit multiple layers simultaneously, (i.e., each base station may employ superposition coding or multi-layer transmission using MIMO operation). The DF SN may decode only a selected subset of the layers from all base stations and treat the remaining layers as noise. A precoding optimization based on the decoded layers may be employed. The DF SN may then transmit a signal that is precoded accordingly to facilitate decoding of all layers at the WTRUs after the signals in different time slots are combined.

In another embodiment using an amplify-and-forward (AF) SN, the AF SN may receive the signals from interfering base stations added over the air. The AF SN may precode the received signals (without decoding) and forward the received signals in a later time slot. The precoding may be optimized such that the desired signal power at the WTRUs is maximized.

The selection procedure for WTRUs that participate in shared relaying and the relaying operation may depend on channel conditions. The signaling flow of channel state information (CSI) feedback and a procedure to acknowledge WTRU pairing and relaying schemes from an SN to base stations and WTRUs is described herein.

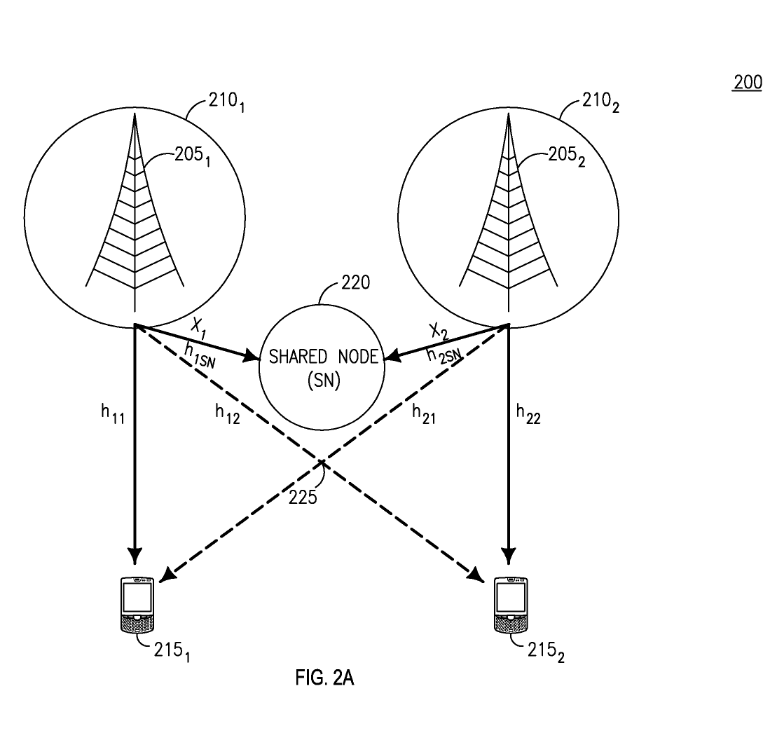

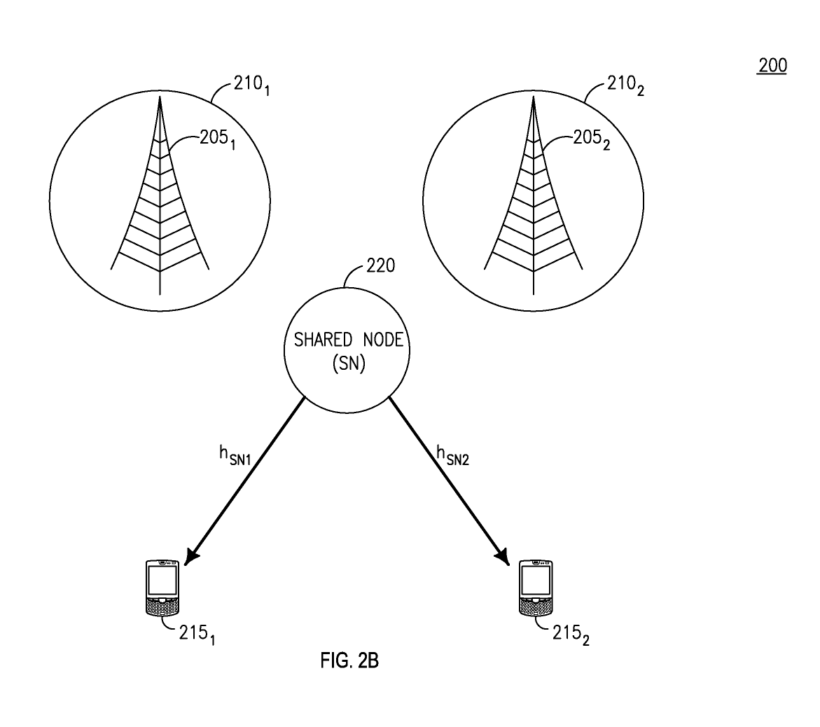

FIG. 2A shows a first transmission phase of a system model of a half-duplex wireless communication system 200. The system 200 may include a first base station (BS) 205₁ in a first cell 210₁, and a second BS 205₂ in a second cell 210₂. A two-cell downlink scenario may be used where the BS 205₁ at cell 210₁ schedules and communicates with its assigned WTRU 215₁, and the BS 205₂ at cell 210₂ schedules and communicates with its assigned WTRU 215₂. The adjacent cells 210₁ and 210₂ may operate in the same resource blocks, (i.e., time and frequency), satisfying a frequency reuse factor of 1. For i=1, 2, BS 205ᵢ may send a codeword CWᵢ to its destination WTRU 215ᵢ. An SN 220 having two antennas may assist both BS and WTRU pairs 205/210 simultaneously by operating in common resource blocks (RBs) of the cells 210. However, inter-cell interference 225 may result due to the close proximity of the neighboring cells 210 and their respective WTRUs 215.

The channels between the BSs 205, the WTRUs 215 and the SN 220 may follow an additive white Gaussian noise (AWGN) model, and the received signals during a first transmission phase, [0,Tₒ], (assuming that the signal is being received from t=0 up to t=Tₒ), as shown in FIG. 2A, are given by:

Y_{SN}=h_{1SN}X₁+h_{2SN}X₂+Z_{SN} Equation (1)

Y_{1,T1}=h₁₁X₁+h₂₁X₂+Z₁, and Equation (2)

Y_{2,T1}=h₁₂X₁+h₂₂X₂+Z₂, Equation (3)

where X₁ is the transmit signal by the BS 205₁, X₂ is the transmit signal by the BS 205₂, Y_{SN} is the received signal at the SN 220, Y_{1,T1} is the received signal at the WTRU 215₁ during the first transmission phase, Y_{2,T1} is the received signal at the WTRU 215₂ during the first transmission phase, h_{1sN}=[h_{1SN,1} h_{1SN,2}] is the channel between the BS 205₁ and two antenna ports of the SN 220, h_{2SN}=[h_{2SN,1} h_{2SN,2}] is the channel between the BS 205₂ and two antenna ports of the SN 220, h₁₁ is the channel between the BS 205₁ and the WTRU 215₁, h₁₂ is the channel between the BS 205₁ and the WTRU 215₂, h₂₁ is the channel between the BS 205₂ and the WTRU 215₁, and h₂₂ is the channel between the BS 205₂ and the WTRU 215₂. Z_{SN} is the noise term observed at SN 220, Z₁ is the noise term observed at WTRU 215₁ and Z₂ is the noise term observed at the WTRU 215₂. For i=1, 2, Xᵢ is the signal of the BS 205ᵢ satisfying the power constraint:

E(Xᵢ²)≦Pᵢ, Equation (4)

where E(.) corresponds to a standard expected value operation and Pᵢ is the allowed maximum transmitting power of BS 205ᵢ for i=1 or 2, and Zᵢ is an independent identically distributed Gaussian noise process with variance of Nᵢ and Z_{SN}=[Z_{SN,1} Z_{SN,2}] with covariance matrix of K_{ZSN}.

In a second transmission phase, (e.g., a different TTI), of the system 200 shown in FIG. 2B, [Tₒ,T], where T is the total duration of the transmission by both of the BSs 205₁ and 205₂, the BSs 205 may refrain from transmitting any messages, and only the SN 220 transmits its signal X_{SN} which is received at the WTRUs 215 as:

Y_{1,T2}=h_{SN1}X_{SN}+Z₁′, and Equation (5A)

Y_{2,T2}=h_{SN2}X_{SN}+Z₂′, Equation (5B)

where Y_{1,T2} is the received signal at the WTRU 215₁ during the second transmission phase, Y_{2,T2} is the received signal at the WTRU 215₂ during the second transmission phase, X_{SN} is the signal vector transmitted by the SN 220, h_{SN1}=[h_{SN1,1} h_{SN1,2}] and h_{SN2}==[h_{SN2,1} h_{SN2,2}] are the channels between the two antenna ports of the SN 220 and the WTRUs 215, respectively, and [h_{SNi,1} h_{SNi,2}] denotes the channel coefficients between the receive antenna of the WTRU 215ᵢ and the two transmit antennas of the SN 220. Zᵢ′ (i=1,2) is an independent identically distributed Gaussian noise process with variance of Nᵢ′ experienced at the WTRUs 215 during the second transmission phase of the system 200.

The transmit vector X_{SN} satisfies the power constraint such that:

tr(E(X_{SN}X_{SN}*))<P_{SN}. Equation (6)

The tr(.) represents the standard trace operation, and P_{SN} is the allowed maximum transmit power of the SN. For simplicity, Tₒ may be equal to T/2 throughout the analysis in each embodiment.

It is assumed that the BS 205ᵢ has channel state information (CSI) of the forward channels to the SN 220, i.e., hᵢᵢ, h_{isN}, and the WTRUs 215 may have optimal CSI of the links from both the BSs 205 and the SN 220. However, in order to fully capitalize the benefits due to relaying, the SN 220 may be assumed to have full CSI of the network.

Common to all proposed transmission schemes described herein, the WTRUs 215 may combine the signals transmitted by both of the BSs 205 during a first time slot and transmitted by the SN 220 during the second time slot. Then, the WTRUs 215 may decode their desired signals using the combined signals.

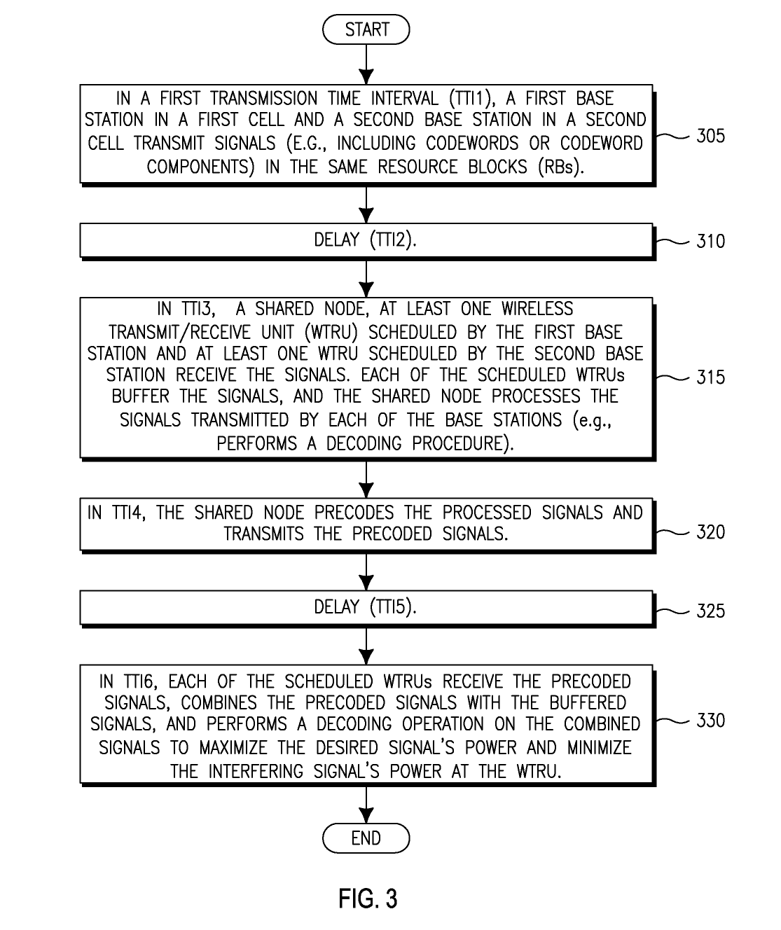

FIG. 3 is a flow diagram of a procedure 300 for processing signals transmitted by the BSs 205 at the SN 220 and the WTRUs 215 to mitigate inter-cell interference. Referring to FIGS. 2A and 3, in a first transmission time interval (TTI1), a first BS 205₁ in a first cell 210₁ and a second BS 205₂ in a second cell 210₂ transmit signals (e.g., including codewords or codeword components) in the same (i.e., common) resource blocks (RBs), (305). After a delay TTI2 (310), in TTI3 an SN 220 and at least one WTRU 215 scheduled by each of the BSs 205 may receive the signals, whereby each of the scheduled WTRUs 215 may buffer the signals, and the SN 220 may process the signals transmitted by each of the BSs 205, (e.g., performs a decoding procedure), (315). In TTI4, the SN 220 may precode the processed signals and transmit the precoded signals (320). After a delay TTI5 (325), in TTI6 each of the scheduled WTRUs 215 receive the precoded signals, combines the precoded signals with the buffered signals, and performs a decoding operation on the combined signals to maximize the desired signal power and minimize the interfering signal power at the scheduled WTRU.

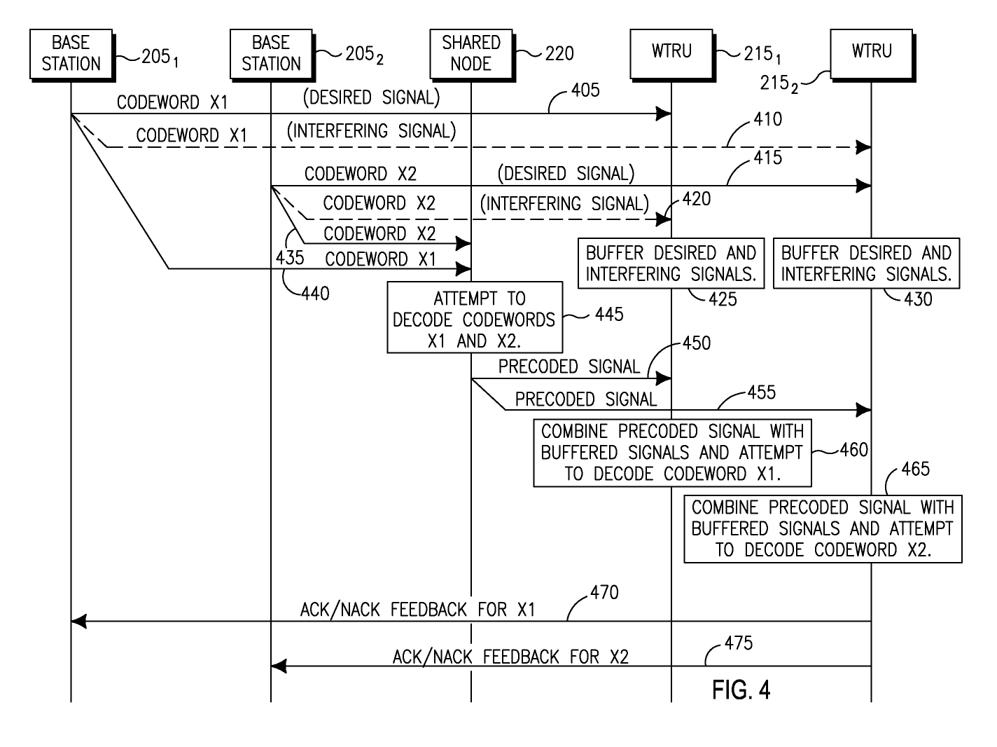

FIG. 4 is a signal flow diagram of a procedure 400 for processing codewords transmitted by the BSs 205 at the SN 220 and the WTRUs 215, and providing hybrid automatic repeat request (HARQ) feedback, (i.e., positive acknowledgement (ACK)/negative acknowledgement (NACK) feedback). A first BS 205₁ may transmit a first codeword X1 (i.e., desired signal) to a first WTRU 215₁ (405). However, a second WTRU 215₂ may also receive the first codeword X1 as an interfering signal (410). At the same time, a second BS 205₂ may transmit a second codeword X2 (i.e., desired signal) to the second WTRU 215₂ (415). However, the second WTRU 215₂ may also receive the second codeword X2 as an interfering signal (420). Each of the first and second WTRUs 215₁ and 215₂ may buffer (i.e., store) the desired and interfering signals including codewords X1 and X2 (425, 430). An SN 220 may also receive the codewords X1 (435) and X2 (440) from the respective BSs 205₁ and 205₂, and attempt to decode the codewords X1 and X2 (445). The SN 220 may then transmit a precoded signal to the first WTRU 215₁ (450), which combines the precoded signal with its buffered signals and attempt to decode the first codeword X1 (455). The SN 220 may also transmit the precoded signal to the second WTRU 215₂ (460), which combines the precoded signal with its buffered signals and attempts to decode the second codeword X2 (465). The first WTRU 215₁ may then transmit ACK/NACK feedback for the first codeword X1 to the first BS 205₁ (470) and the second WTRU 215₂ may then transmit ACK/NACK feedback for the second codeword X2 to the second BS 205₂ (475). If any one of the codewords X1 and X2 fails, then the corresponding BS 205 may retransmit the same codeword. Combining of the soft bits from the original transmission and retransmissions(s) may be performed is in existing HARQ mechanisms.

In a distributed interference alignment scheme, as the base stations perform their transmissions independently in the first time slot without any type of coordination, the transmitted signals interfere with each other at the destinations. Due to the broadcast nature of the transmission, the SN 220 receives the signals from both BSs 205.

In the first time slot, the communication between the BSs 205 and the SN 220 may be represented as a multiple access communication and the capacity may be written as, assuming:

E[Z_{SN}Z_{SN}*]=I, Equation (7)

R₁^{SN}≦0.5 log(1+(|h_{1SN,1}|²+|h_{1SN,2}|²)P₁), Equation (8)

R₂^{SN}≦0.5 log(1+(|h_{2SN,1}|²+|h_{2SN,2}|²)P₂), and Equation (9)

R₁^{SN}+R₂^{SN}≦0.5 log det(I+HKₓH*), Equation (10)

where H=[h_{1SN}^{T} h_{2SN}^{T}], Kₓ=diag(P₁,P₂) and I is an identity matrix. Assuming that the SN 220 is able to decode the messages in the first time slot, it may be able to perform a transmission strategy so that the desired and interfering signals can be separated by the WTRUs 215 at the end of the second time slot. Such a transmission strategy is to apply precoding at the SN 220 and transmit a linear combination of the two messages, X_{SN}. The precoding matrix is designed such that the received signals over two time slots are aligned properly at the destinations and the interfering signals may be eliminated completely by applying appropriate linear filters at the receivers.

In the precoding and decoding operations, if the SN 220 successfully decodes the messages transmitted by the BSs 205 in the first time slot [0, T₀], the BSs 205 may apply a precoding matrix to the conjugates of the decoded messages before transmitting the composite signals. Then, the signal transmitted by the SN 220 in the second time slot [T₀, T] may be written as:

$$\begin{matrix}{X}_{SN} = [ \begin{matrix}{t}_{11} {X}_{1}^{*} + {t}_{12} {X}_{2}^{*} \\ {t}_{21} {X}_{1}^{*} + {t}_{22} {X}_{2}^{*}\end{matrix} ] = t \cdot [ \begin{matrix}{X}_{1}^{*} \\ {X}_{2}^{*}\end{matrix} ] , \\ where \text{:} & Equation ( 11 ) \\ t = [ \begin{matrix}{t}_{11} {t}_{12} \\ {t}_{21} {t}_{22}\end{matrix} ] , & Equation ( 12 )\end{matrix}$$

is the precoding matrix with corresponding entries t₁₁, t₁₂, t₂₁ and t₂₂, and Xᵢ*, i=1,2, are the complex conjugates of the messages, Xᵢ, i=1,2. The received signals at the WTRU 215₁ and the WTRU 215₂, denoted as Y_{1,T2} and Y_{2,T2} respectively, may then be written as:

Y_{1,T2}=h_{SN1}X_{SN}+Z₁′=(h_{SN1,1}t₁₁+h_{SN1,2}t₂₁)X₁*+(h_{SN1,1}^{t}₁₂+h_{SN1,2}t₂₂)X₂*+Z₁′, Equation (13)

Y_{2,T2}=h_{SN2}X_{SN}+Z₂′=(h_{SN2,1}t₁₁+h_{SN2,2}t₂₁)X₁*+(h_{SN2,1}t₁₂+h_{SN2,2}t₂₂)X₂*+Z₂′. Equation (14)

Over two time slots, the destinations receive signals transmitted by the base stations as shown above in equations (1), (2) and (3), and transmitted by the SN 220 as shown above in equations (13) and (14). In the design of the system, one goal is to design the precoding matrix t such that when these two signals are appropriately combined, the interfering signal is eliminated completely. To achieve this goal, it may be sufficient for the following equations to hold:

$$\begin{matrix}\begin{matrix}\begin{matrix}{h}_{SN 1 , 1} {t}_{11} + {h}_{SN 1 , 2} {t}_{21} = {kh}_{21} \\ {h}_{SN 1 , 1} {t}_{12} + {h}_{SN 1 , 2} {t}_{22} = - {kh}_{11}\end{matrix} \\ {h}_{SN 2 , 1} {t}_{11} + {h}_{SN 2 , 2} {t}_{21} = {kh}_{22}\end{matrix} \\ {h}_{SN 2 , 1} {t}_{12} + {h}_{SN 2 , 2} {t}_{22} = - {kh}_{12}\end{matrix} \} \\ or \\ [ \begin{matrix}{h}_{SN 1 , 1} {h}_{SN 1 , 2} \\ {h}_{SN 2 , 1} {h}_{SN 2 , 2}\end{matrix} ] \cdot [ \begin{matrix}{t}_{11} {t}_{12} \\ {t}_{21} {t}_{22}\end{matrix} ] = k [ \begin{matrix}{h}_{21} & - {h}_{11} \\ {h}_{22} & - {h}_{12}\end{matrix} ] , \qquad Equation ( 15 )$$

where k is a parameter used to satisfy the total power constraint of the SN 220.

Then, the received signals at the WTRUs 215 in the second time slot may be written as:

Y_{1,T2}=kh₂₁X₁*−kh₁₁X₂*+Z₁′, and Equation (16)

Y_{2,T2}=kh₂₂X₁*−kh₁₂X₂*+Z₂′, and Equation (17)

Combining equations (1), (2), (3), (16) and (17), the overall signal received at the destinations over two time slots is then written as:

$$\begin{matrix}[ \begin{matrix}{Y}_{1 , T 1} \\ {Y}_{1 , T 2}\end{matrix} ] = [ \begin{matrix}{X}_{1} & {X}_{2} \\ - {kX}_{2}^{*} & k {X}_{1}^{*}\end{matrix} ] \cdot [ \begin{matrix}{h}_{11} \\ {h}_{21}\end{matrix} ] + [ \begin{matrix}{Z}_{1} \\ {Z}_{1}^{′}\end{matrix} ] , \\ and & Equation ( 18 ) \\ [ \begin{matrix}{Y}_{2 , T 1} \\ {Y}_{2 , T 2}\end{matrix} ] = [ \begin{matrix}{X}_{1} & {X}_{2} \\ - {kX}_{2}^{*} & k {X}_{1}^{*}\end{matrix} ] \cdot [ \begin{matrix}{h}_{12} \\ {h}_{22}\end{matrix} ] + [ \begin{matrix}{Z}_{2} \\ {Z}_{2}^{′}\end{matrix} ] . & Equation ( 19 )\end{matrix}$$

In the decoding procedure, before applying a receive filter to the overall signal, the WTRUs 215 first apply a conjugate operation on the signals received in the second time slot, resulting in Equations (18) and (19) to be modified as follows:

$$\begin{matrix}[ \begin{matrix}{Y}_{1 , T 1} \\ {Y}_{1 , T 2}^{*}\end{matrix} ] = [ \begin{matrix}{h}_{11} & {h}_{21} \\ {kh}_{21}^{*} & - k {h}_{11}^{*}\end{matrix} ] \cdot [ \begin{matrix}{X}_{1} \\ {X}_{2}\end{matrix} ] + [ \begin{matrix}{Z}_{1} \\ {Z}_{1}^{′ *}\end{matrix} ] , \\ and & Equation ( 20 ) \\ [ \begin{matrix}{Y}_{2 , T 1} \\ {Y}_{2 , T 2}^{*}\end{matrix} ] = [ \begin{matrix}{h}_{12} & {h}_{22} \\ {kh}_{22}^{*} & - k {h}_{12}^{*}\end{matrix} ] \cdot [ \begin{matrix}{X}_{1} \\ {X}_{2}\end{matrix} ] + [ \begin{matrix}{Z}_{2} \\ {Z}_{2}^{′ *}\end{matrix} ] . & Equation ( 21 )\end{matrix}$$

From equations (20) and (21), it may be observed that X₁ and X₂ may be extracted without interference at WTRUs 215₁ and 215₂, respectively, by applying such linear filters that the interfering signal components are cancelled completely. For achieving a signal where interference signals are canceled completely, the following receive processing may be employed at the WTRUs 215₁ and 215₂, respectively, where

$$\begin{matrix}\begin{matrix}[ {kh}_{11}^{*} & {h}_{21} ] [ \begin{matrix}{Y}_{1 , T 1} \\ {Y}_{1 , T 2}^{*}\end{matrix} ] =\end{matrix} \begin{matrix}k ( {\vert {h}_{11} \vert}^{2} + {\vert {h}_{21} \vert}^{2} ) {X}_{1} + \\ {kh}_{11}^{*} {Z}_{1} + {h}_{21} {Z}_{1}^{′ *} ,\end{matrix} \\ and & Equation ( 22 ) \\ \begin{matrix}[ {kh}_{22}^{*} & - {h}_{12} ] [ \begin{matrix}{Y}_{2 , T 1} \\ {Y}_{2 , T 2}^{*}\end{matrix} ] = \begin{matrix}k ( {\vert {h}_{22} \vert}^{2} + {\vert {h}_{12} \vert}^{2} ) {X}_{2} + \\ {kh}_{22}^{*} {Z}_{2}^{′ *} - {h}_{12} {Z}_{2}^{′ *} .\end{matrix}\end{matrix} & Equation ( 23 )\end{matrix}$$

From equations (22) and (23), it may be observed that the interfering signal is cancelled completely and only the desired signal and the noise remain after the filtering operation. In the special case when k=1, the transmission becomes similar to an Alamouti coding scheme.

Assuming E[|Z₁′|²]=E[|Z₂′|²]=1, and that Gaussian inputs are used at the BSs 205, the achievable rates may be written by using equations (22) and (23) as:

$$\begin{matrix}{R}_{1}^{WTRU} ( k ) \leq 0.5 log ( 1 + \frac{{\vert k \vert}^{2} {( {\vert {h}_{11} \vert}^{2} + {\vert {h}_{21} \vert}^{2} )}^{2} {P}_{1}}{{\vert {kh}_{11} \vert}^{2} {N}_{1} + {\vert {h}_{21} \vert}^{2} {N}_{1}^{′}} ) , \\ and & Equation ( 24 ) \\ {R}_{2}^{WTRU} ( k ) \leq 0.5 log ( 1 + \frac{{\vert k \vert}^{2} {( {\vert {h}_{22} \vert}^{2} + {\vert {h}_{12} \vert}^{2} )}^{2} {P}_{2}}{{\vert {kh}_{22} \vert}^{2} {N}_{2} + {\vert {h}_{12} \vert}^{2} {N}_{2}^{′}} ) . & Equation ( 25 )\end{matrix}$$

The objective is to maximize the sum rate (R₁+R₂) which is constrained by the multiple-access rates at the SN 220 given in equations (8), (9) and (10)m and the achievable rates at the receivers in equations (24) and (25) is subject to the SN power constraint:

$$\begin{matrix}\begin{matrix}{max}_{k} ( min ( {R}_{1}^{SN} + {R}_{2}^{SN} , min ( {R}_{1}^{SN} , {R}_{1}^{WTRU} ( k ) ) + \\ min ( {R}_{2}^{SN} , {R}_{2}^{WTRU} ( k ) ) ) ) ,\end{matrix} \\ such that \text{:} & Equation ( 26 A ) \\ tr \{ E ⌊ {X}_{SN} {X}_{SN}^{*} ⌋ \} \leq {P}_{SN} . & Equation ( 26 B )\end{matrix}$$

While maximizing the sum rate, the first constraint is due to maximum total power of the SN 220 which may be written as:

|t₁₁|²P₁+|t₁₂|²P₂+|t₂₁|²P₁+|t₂₂|²P₂≦P_{SN}, Equation (27)

and the second constraint may be due to the design of the precoding matrix from equation (15) which may be re-written as:

$$[ \begin{matrix}{t}_{11} & {t}_{12} \\ {t}_{21} & {t}_{22}\end{matrix} ] = {k [ \begin{matrix}{h}_{SN 1 , 1} & {h}_{SN 1 , 2} \\ {h}_{SN 2 , 1} & {h}_{SN 2 , 2}\end{matrix} ]}^{- 1} [ \begin{matrix}{h}_{21} & - {h}_{11} \\ {h}_{22} & - {h}_{12}\end{matrix} ] . \qquad Equation ( 28 )$$

It may be possible to obtain the closed form precoding matrix satisfying the desired conditions to align the interference as follows. From equations (24) and (25) it may be observed that the throughput expressions are increasing functions of k and hence the largest k value satisfying equations (27) and (28) is optimal which gives the optimal precoding matrix. From equation (28), each t_{i,j}=1,2 can be explicitly written as a function of k, so that equation (27) may be satisfied with equality which will lead to largest k value.

The achievable rates in equation (26A) may be improved by incorporating selection relaying proposed elsewhere. In particular, for the cases where BS-to-SN channels limit the transmission rates even with respect to direct transmission without the SN 220, the BSs may choose not to exploit the SN 220 and resume transmission in the second time slot. However in the embodiments described herein, only the cases where relaying is beneficial over direct communications are considered.

It may also be possible to extend the optimization problem as described above to a more general one. First, the precoding matrix t may be set to satisfy the expression:

$$[ \begin{matrix}{h}_{SN 1 , 1} & {h}_{SN 1 , 2} \\ {h}_{SN 2 , 1} & {h}_{SN 2 , 2}\end{matrix} ] \cdot [ \begin{matrix}{t}_{11} & {t}_{12} \\ {t}_{21} & {t}_{22}\end{matrix} ] = [ \begin{matrix}{k}_{1} & 0 \\ 0 & {k}_{2}\end{matrix} ] [ \begin{matrix}{h}_{21} & - {h}_{11} \\ {h}_{22} & - {h}_{12}\end{matrix} ] . \qquad Equation ( 29 )$$

Here the factor k in equation (15) is replaced to a diagonal matrix with elements k₁ and k₂. Then, the received signal in the second transmission phase may be expressed as:

Y_{1,T2}=k₁h₂₁X₁*−k₁h₁₁X₂*+Z₁′, and Equation (30)

Y_{2,T2}=k₂h₂₂X₁*−k₂h₁₂X₂*+Z₂′. Equation (31)

The received signal in both transmission phases may be expressed as:

$$\begin{matrix}[ \begin{matrix}{Y}_{1 , T 1} \\ {Y}_{1 , T 2}^{*}\end{matrix} ] = [ \begin{matrix}{h}_{11} & {h}_{21} \\ {k}_{1} {h}_{21}^{*} & - {k}_{1} {h}_{11}^{*}\end{matrix} ] \cdot [ \begin{matrix}{X}_{1} \\ {X}_{2}\end{matrix} ] + [ \begin{matrix}{Z}_{1} \\ {Z}_{1}^{′ *}\end{matrix} ] , \\ and & Equation ( 32 ) \\ [ \begin{matrix}{Y}_{2 , T 1} \\ {Y}_{2 , T 2}^{*}\end{matrix} ] = [ \begin{matrix}{h}_{12} & {h}_{22} \\ {k}_{2} {h}_{22}^{*} & - {k}_{2} {h}_{12}^{*}\end{matrix} ] \cdot [ \begin{matrix}{X}_{1} \\ {X}_{2}\end{matrix} ] + [ \begin{matrix}{Z}_{2} \\ {Z}_{2}^{′ *}\end{matrix} ] . & Equation ( 33 )\end{matrix}$$

Projecting the above expressions on and └k₁h₁₁*−h₂₁┘ and └k₂h₂₂*−h₁₂┘, respectively, the following expressions are obtained:

$$\begin{matrix}[ \begin{matrix}{k}_{1} {h}_{11}^{*} & {h}_{21}\end{matrix} ] [ \begin{matrix}{Y}_{1 , T 1} \\ {Y}_{1 , T 2}^{*}\end{matrix} ] = {k}_{1} ( {\vert {h}_{11} \vert}^{2} + {\vert {h}_{21} \vert}^{2} ) {X}_{1} + {k}_{1} {h}_{11}^{*} {Z}_{1} + {h}_{21} {Z}_{1}^{′ *} , \\ and & Equation ( 34 ) \\ [ \begin{matrix}{k}_{2} {h}_{22}^{*} & - {h}_{12}\end{matrix} ] [ \begin{matrix}{Y}_{2 , T 1} \\ {Y}_{2 , T 2}^{*}\end{matrix} ] = {k}_{2} ( {\vert {h}_{22} \vert}^{2} + {\vert {h}_{12} \vert}^{2} ) {X}_{2} + {k}_{2} {h}_{22}^{*} {Z}_{2} - {h}_{12} {Z}_{2}^{′ *} . & Equation ( 35 )\end{matrix}$$

The achievable rate at WTRUs 215₁ and 215₂ may be expressed as:

$$\begin{matrix}{R}_{1}^{WTRU} ( {k}_{1} ) \leq 0.5 log ( 1 + \frac{{\vert {k}_{1} \vert}^{2} {( {\vert {h}_{11} \vert}^{2} + {\vert {h}_{21} \vert}^{2} )}^{2} {P}_{1}}{{\vert {k}_{1} {h}_{11} \vert}^{2} {N}_{1} + {\vert {h}_{21} \vert}^{2} {N}_{1}} ) , \\ and & Equation ( 36 ) \\ {R}_{2}^{WTRU} ( {k}_{2} ) \leq 0.5 log ( 1 + \frac{{\vert {k}_{2} \vert}^{2} {( {\vert {h}_{22} \vert}^{2} + {\vert {h}_{12} \vert}^{2} )}^{2} {P}_{2}}{{\vert {k}_{2} {h}_{22} \vert}^{2} {N}_{2} + {\vert {h}_{12} \vert}^{2} {N}_{2}} ) . & Equation ( 37 )\end{matrix}$$

The advantage of using different k parameters in precoding formulation is that the optimization problem may be solved with constraints on the power for each transmit antenna at the SN 220, instead of total power as:

$$\begin{matrix}\begin{matrix}{max}_{{k}_{1} , {k}_{2}} ( min ( {R}_{1}^{SN} + {R}_{2}^{SN} , min ( {R}_{1}^{SN} , {R}_{1}^{WTRU} ( {k}_{1} ) ) + \\ min ( {R}_{2}^{SN} , {R}_{2}^{WTRU} ( {k}_{2} ) ) ) ) ,\end{matrix} \\ such that \text{:} & Equation ( 38 ) \\ E ⌊ {\vert {X}_{SN , 1} \vert}^{2} ⌋ \leq {P}_{SN , 1} , \\ and & Equation ( 39 ) \\ E ⌊ {\vert {X}_{SN , 2} \vert}^{2} ⌋ \leq {P}_{SN , 2} . & Equation ( 40 )\end{matrix}$$

Here, the first constraint sets parameter k₁ and second sets parameter k₂, X_{SN,1} and X_{SN,2} are transmit signals from the two antennas of the SN 220, respectively, and P_{SN,1} and P_{SN,2} are power constraints on the two antennas of the SN 220, respectively.

SN precoding may be optimized in an embodiment involving DF shared relaying. The SN 220 may not generate its signal to put the interference and desired signals in orthogonal subspace. Rather, it may employ a general precoding matrix given by:

$${X}_{SN} = [ \begin{matrix}{t}_{11} {X}_{1} + {t}_{12} {X}_{2} \\ {t}_{21} {X}_{1} + {t}_{22} {X}_{2}\end{matrix} ] . \qquad Equation ( 41 )$$

Then, the received signals at the destinations in the second time slot may be:

Y_{1,T2}=h_{SN1}X_{SN}+Z₁′=(h_{SN1,1}t₁₁+h_{SN1,2}t₂₁)X₁+(h_{SN1,1}t₁₂+h_{SN1,2}t₂₂)X₂+Z₁′, and Equation (42)

Y_{2,T2}=h_{SN2}X_{SN}+Z₂′=(h_{SN1,2}t₁₁+h_{SN2,2}t₂₁)X₁+(h_{SN2,1}t₁₂+h_{SN2,2}t₂₂)X₂+Z₂′. Equation (43)

Considering the received signals in the first time slot as given in equations (1), (2) and (3), along with the received signals in the second time slot, the overall received signal may be written as:

Y_{1T}=w₁ₐX₁+w₂ₐX₂+Z_{1T}; and Equation (44)

Y_{2T}=w_{1b}X₁+w_{2b}X₂+Z_{2T}; and Equation (45)

where:

w₁ₐ=[h₁₁h_{SN1}t₁]^{T}, Equation (46)

w₂ₐ=[h₂₁h_{SN1}t₂]^{T}, Equation (47)

w_{1b}=[h₁₂h_{SN2}t₁]^{T}, Equation (48)

w_{2b}=[h₂₂h_{SN2}t₂]^{T}, Equation (49)

t₁=[t₁₁t₂₁]^{T}, and Equation (50)

t₂=[t₁₂t₂₁]^{T}. Equation (51)

Here,

Y_{1T}=[Y_{1,T1}Y_{1,T2}]^{T}, Equation (52)

Y_{2T}=[Y_{2,T1}Y_{2,T2}]^{T}, Equation (53)

Z_{1T}=[Z₁Z₁′]^{T}, and Equation (54)

Z_{2T}=[Z₂Z₂′]^{T}. Equation (55)

For decoding, the destinations employ MMSE decoding to compensate for the effect of interference, where:

Z′_{eff1}=w₂ₐX₂+Z_{1T}, and Equation (56)

Z′_{eff2}=w_{1b}X₁+Z_{2T}, Equation (57)

which have the covariance matrices of K_{Zeff1} and K_{Zeff2}, respectively.

Then, MMSE filtering may be applied to the received signals as:

$$\begin{matrix}{K}_{Zeff 1}^{- \frac{1}{2}} {Y}_{1 T} = {K}_{Zeff 1}^{- \frac{1}{2}} {w}_{1 a} {X}_{1} + {Z}_{eff 1}^{′} ; \\ and & Equation ( 58 ) \\ {K}_{Zeff 2}^{- \frac{1}{2}} {Y}_{2 T} = {K}_{Zeff 2}^{- \frac{1}{2}} {w}_{2 b} {X}_{2} + {Z}_{eff 2}^{′} , & Equation ( 59 )\end{matrix}$$

where Z′_{eff1} and Z′_{eff2} have unitary covariance matrices. Then, the received signal-to-noise (SNR) at WTRUs 215₁ and 215₂ for X₁, X₂, respectively may be re-written as:

SNRₘₘₛₑ₁^{optbf}=P₁w₁ₐ*K_{Zeff1}⁻¹w₁ₐ, and Equation (60)

SNRₘₘₛₑ₂^{optbf}=P₂w_{2b}*K_{Zeff2}⁻¹w_{2b}. Equation (61)

The SNRs at the WTRUs 215₁ and 215₂ may be maximized over the set of t₁ and t₂ precoding vectors, which satisfy:

tr{E[X_{SN}X_{SN}*]}=P_{SN}. Equation (62)

From the maximum SNRₘₘₛₑᵢ, i=1,2, the overall achievable rates may be found as:

R₁^{optbf}≦0.5 log(1+SNRₘₘₛₑ₁), and Equation (63)

R₂^{optbf}≦0.5 log(1+SNRₘₘₛₑ₂). Equation (64)

Similarly, the overall rates along with the decoding constraints at the SN 220 given in equations (8), (9) and (10), the following rates may provide the overall rates achieved by MMSE decoding:

max(min(R₁^{SN}+R₂^{SN},min(R₁^{SN},R₁^{optbf})+min(R₂^{SN},R₂^{optbf}))) such that tr{E└X_{SN}X_{SN}*┘}≦P_{SN}. Equation (65)

However, the sum-rate given as above may be maximized by properly choosing the SN precoding matrix X_{SN}, which is obtained by searching among the possible [t₁₁,t₁₂,t₂₁,t₂₂] set subject to the SN power constraint. Hence, given the channel gains and node powers, the above optimization determines the optimal [t₁₁*,t₁₂*,t₂₁*,t₂₂*] set. However, due to the non-convexity of the throughput expressions, it is infeasible to obtain optimal closed form an SN precoding matrix. Hence, exhaustive search is used in determining the precoding matrix.

Another embodiment involving amplify-and-forward shared relaying is now described. The relaying transmission scheme is generalized to incorporate AF transmission at the SN 220. In AF, the SN does not attempt to decode the signals transmitted from the base stations in the first transmission phase. In the second transmission phase, it amplifies the overall signal it received in the first transmission phase in accordance to its power constraint.

Since the SN 220 is not obliged to decode the base station messages, the rate limitation to guarantee the decodability of the source messages, as given in equations (8), (9) and (10) is removed. However, since the overall received signal is corrupted by the noise, the AF scheme causes noise amplification.

Considering the received signals as given in equations (1), (2), (3), (5A) and (5B), the SN 220 may generate a precoding matrix which is obtained by multiplying the received signals at each antenna by real β₁ and β₂ respectively, which gives the SN transmitted signal:

X_{SN}([X_{SN1}X_{SN2})]^{T}), Equation (66)

where:

X_{SN1}=β₁([h_{1SN,1}h_{2SN,1}][X₁X₂]^{T}+Z_{SN1,1}), and Equation (67)

X_{SN2}=β₂([h_{1SN,2}h_{2SN,2}][X₁X₂]^{T}+Z_{SN2,1}). Equation (68)

Here β₁ and β₂ are the amplifying coefficients at the two antennas of SN 220, respectively. The AF SN precoding may be extended to obtain better performance, in particular more diversity gain. A more general amplifying operation may be expressed as follows such that X_{SN1} and X_{SN2} are given as:

X_{SN1}=β₁₁([h_{1SN,1}h_{2SN,1}][X₁X₂]^{T}+Z_{SN1,1})+β₁₂([h_{1SN,2}h_{2SN,2}][X₁X₂]^{T}+Z_{SN2,1}); and Equation (69)

X_{SN2}=β₂₁([h_{1SN,2}h_{2SN,2}][X₁X₂]^{T}+Z_{SN2,1})+β₂₂([h_{1SN,1}h_{2SN,1}][X₁X₂]^{T}+Z_{SN1,1}), Equation (70)

where β₁₁, β₁₂, β₂₁ and β₂₂ are the amplification coefficients at the antennas.

Accordingly, each transmitted signal may be linear combination of two received signals. The beta values may be complex, which may provide gain values similar to multi-user (MU)-MIMO. However, for simplicity, it is assumed that β₁₁=β₁₂ and β₂₁=β₂₂.

Due to SN power constraint, the transmitted signal may satisfy tr(E(X_{SN}X_{SN}*))<P_{SN} which is equal to:

β₁²(|h_{1SN,1}|²P₁+|h_{2SN,1}|²P₂+1)+β₂²(|h_{1SN,2}|²P₁+|h_{2SN,1}|²P₂+1)≦P_{SN}, Equation (71)

where P₁ and P₂ are the source transmission powers.

Following equations (5A) and (5B), and using X_{SN} with AF, the received signals at the WTRUs 215₁ and 215₂ may be obtained as,

$$\begin{matrix}[ \begin{matrix}{Y}_{1 , T 1} \\ {Y}_{1 , T 2}\end{matrix} ] = [ \begin{matrix}{h}_{11} & {h}_{21} \\ {h}_{11 , eff} & {h}_{21 , eff}\end{matrix} ] [ \begin{matrix}{X}_{1} \\ {X}_{2}\end{matrix} ] + [ \begin{matrix}{Z}_{SN 1 , 1} \\ {Z}_{1 , eff}\end{matrix} ] , \\ and & Equation ( 72 ) \\ [ \begin{matrix}{Y}_{2 , T 1} \\ {Y}_{2 , T 2}\end{matrix} ] = [ \begin{matrix}{h}_{12} & {h}_{22} \\ {h}_{12 , eff} & {h}_{22 , eff}\end{matrix} ] [ \begin{matrix}{X}_{1} \\ {X}_{2}\end{matrix} ] + [ \begin{matrix}{Z}_{SN 2 , 1} \\ {Z}_{2 , eff}\end{matrix} ] , \\ where \text{:} & Equation ( 73 ) \\ {h}_{11 , eff} = {β}_{1} {h}_{SN 1 , 1} {h}_{1 SN , 1} + {β}_{2} {h}_{SN 1 , 2} {h}_{1 SN , 2} , & Equation ( 74 ) \\ {h}_{21 , eff} = {β}_{1} {h}_{SN 1 , 1} {h}_{2 SN , 1} + {β}_{2} {h}_{SN 1 , 2} {h}_{2 SN , 2} , & Equation ( 75 ) \\ {Z}_{1 , eff} = {β}_{1} {h}_{SN 1 , 1} {Z}_{ SN 1 , 1} + {β}_{2} {h}_{SN 1 , 2} {Z}_{ SN 2 , 2} + {Z}_{1}^{2} , & Equation ( 76 ) \\ {h}_{12 , eff} = {β}_{1} {h}_{SN 2 , 1} {h}_{1 SN , 1} + {β}_{2} {h}_{SN 2 , 2} {h}_{1 SN , 2} , & Equation ( 77 ) \\ {h}_{22 , eff} = {β}_{1} {h}_{SN 2 , 1} {h}_{2 SN , 1} + {β}_{2} {h}_{SN 2 , 2} {h}_{2 SN , 2} , \\ and & Equation ( 78 ) \\ {Z}_{2 , eff} = {β}_{1} {h}_{SN 2 , 1} {h}_{ SN 1 , 1} + {β}_{2} {h}_{SN 2 , 2} {Z}_{SN 2 , 2} + {Z}_{2}^{2} . & Equation ( 79 )\end{matrix}$$

Then, denoting:

v₂ₐ=[h₂₁h_{21,eff}]^{T},v₁ₐ=[h₁₁h_{11,eff}]^{T}, and Equation (80)

Z_{1,mmse}=v₂ₐX₂+[Z_{R1,1}Z_{1,eff}]^{T}, Equation (81)

the MMSE receiver at the WTRU 215₁ results in the SNR of:

SNRₘₘₛₑ₁^{AF}=P₁v₁ₐ*K_{Z1.mmse}⁻¹v₁ₐ. Equation (82)

Similarly at the WTRU 215₂,

v_{1b}=[h₁₂h_{12,eff}]^{T}, Equation (83)

v_{2b}=[h₂₂h_{22,eff}]^{T}, and Equation (84)

Z_{2,mmse}=v_{1b}X₁+[Z_{SN2,1}Z_{2,eff}]^{T}, Equation (85)

the SNR at WTRU 215₂ with MMSE is:

SNRₘₘₛₑ₂^{AF}=P₂v_{2b}*K_{Z2.mmse}⁻¹v_{2b}. Equation (86)

Overall achievable rates for AF transmission is then given by,

R₁^{AF}≦0.5 log(1+SNRₘₘₛₑ₁^{AF}), and Equation (87)

R₂^{AF}≦0.5 log(1+SNRₘₘₛₑ₂^{AF}). Equation (88)

The achievable rates obtained by AF transmission may not be limited by the decoding constraints at the SN given by equations (8), (9) and (10), hence R₁ and R₂ may provide the end-to-end achievable rates with optimized sum-rate as follows:

max(R₁^{AF}+R₂^{AF})s.t.tr{E[X_{SN}X_{SN}*]}≦P_{SN}. Equation (89)

Based on the throughput expression of AF transmission as provided above, the SN 220 may determine optimal scaling vector β=[β₁, β₂] constrained by its transmission power as well as the channel gains in the system 200.

In yet another embodiment, a partial DF shared relaying is provided. The BSs 205 may employ message splitting, (i.e., split their codewords into two pieces). The SN 220 may decode only one of these splits and assist in transmission, whereas the other split is directly transmitted to the WTRU 215 without use of the SN 220. The power and rate allocated to each split may be determined by the overall channel gains in the network, as well as power constraints at the nodes, (i.e., BSs 205 and WTRUs 215).

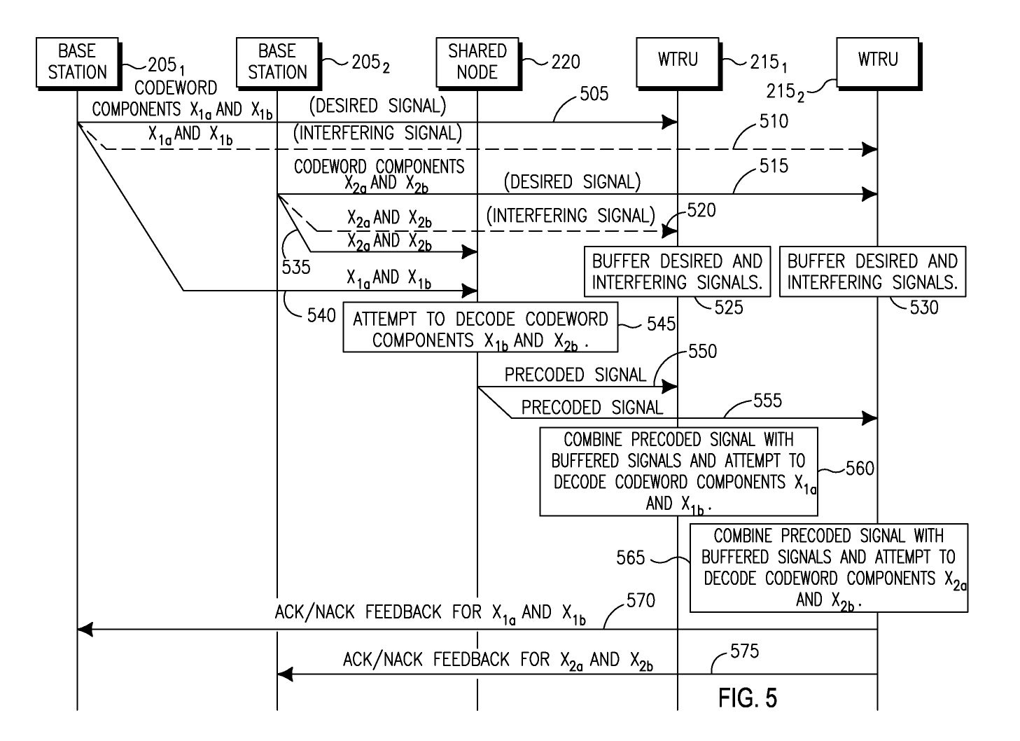

FIG. 5 is a signal flow diagram of a partial DF shared relaying procedure 500. A first BS 205₁ may transmit a first set of codeword components X₁ₐ and X_{1b} (i.e., desired signal) to a first WTRU 215₁ (505). However, a second WTRU 215₂ may also receive the first set of codeword components X₁ₐ and X_{1b} in an interfering signal (510). A second BS 205₂ may transmit a second set of codeword components X₂ₐ and X_{2b} (i.e., desired signal) to the second WTRU 215₂ (515). However, the second WTRU 215₂ may also receive the first set of codeword components X₁ₐ and X_{1b} in an interfering signal (520). Each of the first and second WTRUs 215₁ and 215₂ may buffer (i.e., store) the desired and interfering signals including the first and second sets of codeword components (525, 530). An SN 220 may also receive the first set of codeword components including X₁ₐ and X_{1b} (535) and the second set of codeword components including X₂ₐ and X_{2b} (540) from the respective BSs 205₁ and 205₂, and attempt to decode only one codeword component from each of the two sets of codeword components (e.g., X_{1b} and X_{2b}) (545). The SN 220 may then transmit a precoded signal to the first WTRU 215₁ (550), which combines the precoded signal with its buffered signals and attempts to decode the first set of codeword components including X₁ₐ and X_{1b} (555). The SN 220 may also transmit a precoded signal to the second WTRU 215₂(560), which combines the precoded signal with its buffered signals and attempts to decode the second set of codeword components including X₂ₐ and X_{2b} (565). The first WTRU 215₁ may then transmit ACK/NACK feedback for codeword components X₁ₐ and X_{1b} to the first BS 205₁ (570), and the second WTRU 215₂ may then transmit ACK/NACK feedback for codeword components X₂ₐ and X_{2b} to the second BS 205₂ (575). If any one of the codeword components fails, then the corresponding BS 205 may retransmit the same codeword components. Combining of the soft bits from the original transmission and retransmissions(s) may be performed is in existing HARQ mechanisms.

The messages at the BSs 205 may be split as:

X₁=X₁ₐ+X_{1b}, and Equation (90)

X₂=X₂ₐ+X_{2b}. Equation (91)

X₁ₐ and X₂ₐ may denote the message splits transmitted via the SN 220, and X_{1b} and X_{2b} are the splits transmitted directly to the WTRUs 215. The input/output relations of the system in the first transmission phase may be given as:

Y_{SN}=h_{1SN}(X₁ₐ+X_{1b})+h_{2SN}(X₂ₐ+X_{2b})+Z_{SN}, Equation (92)

Y_{1,T1}=h₁₁(X₁ₐ+X_{1b})+h₂₁(X₂ₐ+X_{2b})+Z₁, and Equation (93)

Y_{2,T1}=h₁₂(X₁ₐ+X_{1b})+h₂₂(X₂ₐ+X_{2b})+Z₂. Equation (93)

The input/output relations of the system in the first transmission phase with the SN precoding matrix may be given as:

$${X}_{SN} = [ \begin{matrix}{t}_{11} {X}_{1 a} + {t}_{12} {X}_{2 a} \\ {t}_{21} {X}_{1 a} + {t}_{22} {X}_{2 a}\end{matrix} ] , \qquad Equation ( 95 )$$

The received signals may be represented as:

Y_{1,T2}=h_{SN1}X_{SN}+Z₁′=(h_{SN1,1}t₁₁+h_{SN1,2}t₂₁)X₁ₐ(h_{SN1,1}t₁₂+h_{SN1,2}t₂₂)X₂ₐ+Z₁′, and Equation (96)

Y_{2,T2}=h_{SN2}X_{SN}+Z₂′=(h_{SN2,1}t₁₁+h_{SN2,2}t₂₁)X₁ₐ(h_{SN2,1}t₁₂+h_{SN2,2}t₂₂)X₂ₐ+Z₂′. Equation (97)

The SN precoding may be used to employ beamforming with the message splits X₁ₐ and X₂ₐ where the matrix coefficients, t₁₁, t₁₂, t₂₁, and t₂₂ are selected to maximize the throughput in the system.

Combining the two signals transmitted over two transmission phases, the following relationships may be obtained:

Y_{1T}=w₁ₐX₁ₐ+w₂ₐX₂ₐ+w_{1b}X_{1b}+w_{2b}X_{2b}+Z_{1T}, and Equation (98)

Y_{2T}=v₁ₐX₁ₐ+v₂ₐX₂ₐ+v_{1b}X_{1b}+v_{2b}X_{2b}+Z_{2T}, Equation (99)

where:

w₁ₐ=[h₁₁h_{SN1}t₁]^{T}, Equation (100)

w₂ₐ=[h₂₁h_{SN1}t₂]^{T}, Equation (101)

w_{1b}=[h₁₁0]^{T}, Equation (102)

w_{2b}=[h₂₁0]^{T}, Equation (103)

v₁ₐ=[h₁₂h_{SN2}t₁]^{T}, Equation (104)

v₂ₐ=[h₂₂h_{SN2}t₂]^{T}, Equation (105)

v_{1b}=[h₁₂0]^{T}, Equation (106)

v_{2b}=[h₂₂0]^{T}, Equation (107)

t₁=[t₁₁t₂₁]^{T}, and Equation (108)

t₂=[t₁₂t₂₁]^{T}. Equation (109)

Here,

Y_{1T}=[Y_{1,T1}Y_{1,T1}]^{T}, Equation (110)

Y_{2T}=[Y_{2,T1}Y_{2,T2}]^{T}, Equation (111)

Z_{1T}=[Z₁Z₁′]^{T}, and Equation (112)

Z_{2T}=[Z₂Z₂′]^{T}. Equation (113)

At a first destination, X₂ₐ and X_{2b} are the interference terms, and similarly X₁ₐ and X_{1b} are the interference terms at a second destination. For simplicity, the received signals may be re-written as:

Y_{1T}=w₁ₐX₁ₐ+w_{1b}X_{1b}+Z_{eff1}, Equation (114)

Y_{2T}=v₂ₐX₂ₐ+v_{2b}X_{2b}+Z_{eff2}, Equation (115)

Z_{eff1}=w₂ₐX₂ₐ+w_{2b}X_{2b}+Z_{1T}, and Equation (116)

Z_{eff2}=v₁ₐX₁ₐ+v_{1b}X_{1b}+Z_{2T}. Equation (117)

The outputs at the destinations may be processed by the corresponding whitening filters to null the effect of interference Z_{eff1} and Z_{eff2}. Hence, at the first destination, input Y_{1T}→K_{Zeff1}^{-1/2}→Y_{1T}^{w} and Y_{2T}→K_{Zeff2}^{-1/2}→Y_{2T}^{w}, where K_{Zeff1} and K_{Zeff2} are the covariance matrices of Z_{eff1} and Z_{eff2}, respectively.

Then, the whitened signals may be written as:

$$\begin{matrix}{Y}_{1 T}^{w} = {w}_{1 a}^{w} {X}_{1 a} + {w}_{1 b}^{w} {X}_{1 b} + {Z}_{eff 1}^{w} , \\ and & Equation ( 118 ) \\ {Y}_{2 T}^{w} = {v}_{2 a}^{w} {X}_{2 a} + {v}_{2 b}^{w} {X}_{2 b} + {Z}_{eff 2}^{w} , \\ where \text{:} & Equation ( 119 ) \\ {w}_{1 a}^{w} = {K}_{Zeff 1}^{- \frac{1}{2}} {w}_{1 a} , & Equation ( 120 ) \\ {w}_{1 b}^{w} = {K}_{Zeff 1}^{- \frac{1}{2}} {w}_{1 b} , & Equation ( 121 ) \\ {Z}_{eff 1}^{w} = {K}_{Zeff 1}^{- \frac{1}{2}} {Z}_{eff 1} , & Equation ( 122 ) \\ {v}_{2 a}^{w} = {K}_{Zeff 2}^{- \frac{1}{2}} {v}_{2 a} , & Equation ( 123 ) \\ {v}_{2 b}^{w} = {K}_{Zeff 2}^{- \frac{1}{2}} {v}_{2 b} , \\ and & Equation ( 124 ) \\ {Z}_{eff 2}^{w} = {K}_{Zeff 2}^{- \frac{1}{2}} {Z}_{eff 2} . & Equation ( 125 )\end{matrix}$$

The parameters Z_{eff1}^{w} and Z_{eff2}^{w} have identity covariance matrices, I. From the whitened signals, following achievable rates at the destinations which form a space division multiple access system (SDMA), and the achievable throughputs may be determined as:

R₁ₐ≦0.5 log(1+|w₁ₐ^{w}|²P₁ₐ), Equation (126)

R_{1b}≦0.5 log(1+|w_{1b}^{w}|²P_{1b}), Equation (127)

R₂ₐ≦0.5 log(1+|v₂ₐ^{w}|²P₂ₐ), Equation (128)

R_{2b}≦0.5 log(1+|v_{2b}^{w}|²P_{2b}), Equation (129)

R₁ₐ+R_{1b}≦0.5 log det(I+H_{w}Kₓ₁H_{w}*), and Equation (130)

R₂ₐ+R_{2b}≦0.5 log det(I+HᵥKₓ₂Hᵥ*), Equation (131)

where:

H_{w}=[w₁ₐ^{w},w_{1b}^{w}], Equation (132)

Hᵥ=[v₂ₐ^{w},v_{2b}^{w}], and Equation (133)

$${K}_{x 1} = [ \begin{matrix}{P}_{1 a} & 0 \\ 0 & {P}_{1 b}\end{matrix} ] , \\ and \\ {K}_{x 2} = [ \begin{matrix}{P}_{2 a} & 0 \\ 0 & {P}_{2 b}\end{matrix} ] . \qquad Equation ( 134 )$$

On the other hand, since X₁ₐ and X₂ₐ may be decoded at the SN 220, the following expressions may denote the achievable rates from the BSs 205 to the SN 220:

$$\begin{matrix}{R}_{1 a}^{SN} \leq 0.5 log ( 1 + \frac{{\vert {h}_{1 SN} \vert}^{2} {P}_{1 a}}{1 + {\vert {h}_{1 SN} \vert}^{2} {P}_{1 b} + {\vert {h}_{2 SN} \vert}^{2} {P}_{2 b}} ) , & Equation ( 135 ) \\ {R}_{2 a}^{SN} \leq 0.5 log ( 1 + \frac{{\vert {h}_{2 SN} \vert}^{2} {P}_{2 a}}{1 + {\vert {h}_{1 SN} \vert}^{2} {P}_{1 b} + {\vert {h}_{2 SN} \vert}^{2} {P}_{2 b}} ) , \\ and & Equation ( 136 ) \\ {R}_{1 a}^{SN} + {R}_{2 a}^{SN} \leq 0.5 log det ( I + \frac{{HK}_{x} {H}^{*}}{1 + {\vert {h}_{1 SN} \vert}^{2} {P}_{1 b} + {\vert {h}_{2 SN} \vert}^{2} {P}_{2 b}} ) , & Equation ( 137 )\end{matrix}$$

where H=[h_{1SN}^{T} h_{2SN}^{T}], Kₓ=diag(P₁ₐ,P₂ₐ) and I is identity matrix. Note that due to power constraints at the sources, the following expressions are obtained P₁ₐ+P_{1b}=P₁ and P₂ₐ+P_{2b}=P₂. The individual rates are given by R₁=R₁ₐ+R_{1b} and R₂=R₂ₐ+R_{2b}. Using Fourier-Motzkin elimination method, the constraints on the sum-rate may be obtained as:

Rₜₒₜ=R₁+R₂. Equation (138)

The following optimization problem provides the optimal power splits; P₁ₐ, P_{1b}, P₂ₐ, and P_{2b} and rates R₁ₐ, R_{1b}, R₂ₐ, and R_{2b}. The aim is to maximize the sum rate of the system 200, i.e., R₁+R₂, so that:

$${max}_{{P 1 a + P 1 b \leq P 1}_{P2a + P2b \leq P2}} {R}_{1} + {R}_{2} s . t . tr \{ E [ {X}_{SN} {X}_{SN}^{*} ] \} \leq {P}_{SN} , \\ E [ {X}_{1} {X}_{1}^{*} ] \leq {P}_{1} , E [ {X}_{2} {X}_{2}^{*} ] \leq {P}_{2} , \qquad Equation ( 139 )$$

From the optimization problem above, the optimal message split powers are obtained that are denoted by P₁ₐ*, P_{1b}*, P₂ₐ*, P_{2b}* at the sources as well as the optimal SN precoding matrix with optimal [t₁₁*,t₁₂*,t₂₁*,t₂₂*] set which in turn give the rates of the splits, R₁ₐ, R_{1b},R₂ₐ, and R_{2b}.

The previously described transmission schemes may require the SN 220 to connect two donor BSs 205 at the same time, and the WTRUs 215 that are helped to connect to a BS 205 and the SN 220.

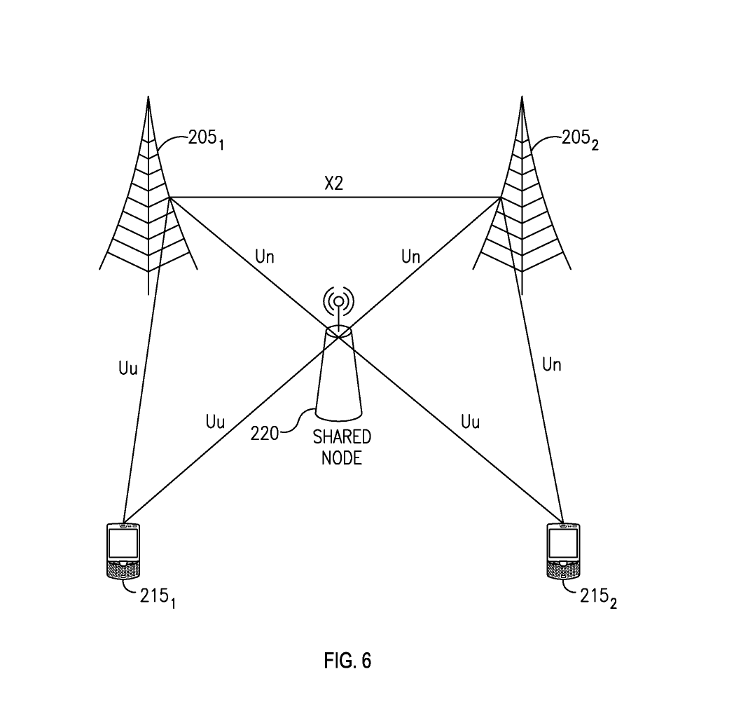

As shown in FIG. 6, a network uses the SN 220 to connect to two BSs 205 (e.g., eNBs) via a Un interface, and the SN 220 connects to two WTRUs 215 via a Uu interface. Each of the WTRUs 215 may connect to its own BS 205 via another Uu interface. An X2 interface may be used for exchanging information between the BSs 205 for cooperation. The pair of WTRUs 215, each of which is served by one of BSs 210 and the SN 220 at the same time, may be identified by providing the SN 220 with a list of WTRUs that each BS 205 serves and needs the SN 220 to help. Once the SN 220 receives the list, a procedure may be performed by the SN 220 to identify a pair of such WTRUs 215. After the SN 220 selects the pair of WTRUs 215, it may inform those selected WTRUs 215 so that they will know to feedback certain information back to the SN 220 and the BSs 205. In addition, after the pair of WTRUs 215 is identified by the SN 220, it may inform the BSs 205 which WTRUs 215 are paired so that when allocating resources in both frequency and time domains, the BSs 205 may use the same resources to transmit the data for the paired WTRUs 215. This may be achieved by designating one of the BSs 205 as a master BS and the other as a slave BS to maintain synchronization in both the frequency and time domains. The resource usage information may also be sent to the paired WTRUs 215 via downlink control channels.

Since the throughput performances of different precoding schemes may be different under different channel conditions, a decision of which precoding scheme to use may be performed by the SN 220 based on the measurement of the channels in all interfaces shown in FIG. 6, and interferences caused by the BSs 205 and their respective WTRUs 215. The selection of the precoding scheme may also be sent to all of the BSs 205 and the WTRUs 215 by the SN 220 sending selection information.

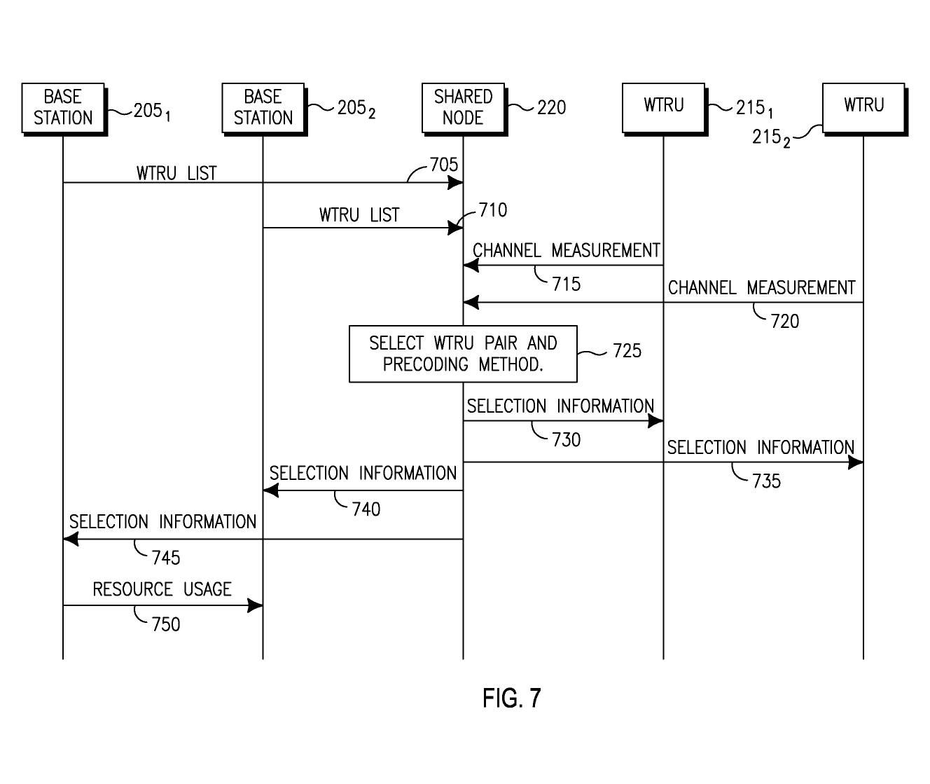

FIG. 7 is a signal flow diagram of a procedure 700 for pairing WTRUs 215 and choosing a precoding method. Each of the BSs 205₁ and 205₂ send a list of WTRUs that need assistance from the SN 220 (705, 710) to be connected to the network or achieve a certain quality of service (QoS). Each of the WTRUs 215₁ and 215₂ may perform a channel measurement and send the channel measurement results to the SN 220 (715, 720). The SN 220 then selects a WTRU pair and a precoding method (725). The SN 220 may then send selection information to each of the selected WTRUs 215₁ and 215₂, and each of the BSs 205₁ and 205₂ (730, 735, 740, 745). The BS 205₁ may then send resource usage information to the BS 205₂ (750) so that two BSs 205 may use the same time and frequency resources to transmit the data for their own WTRU 215.

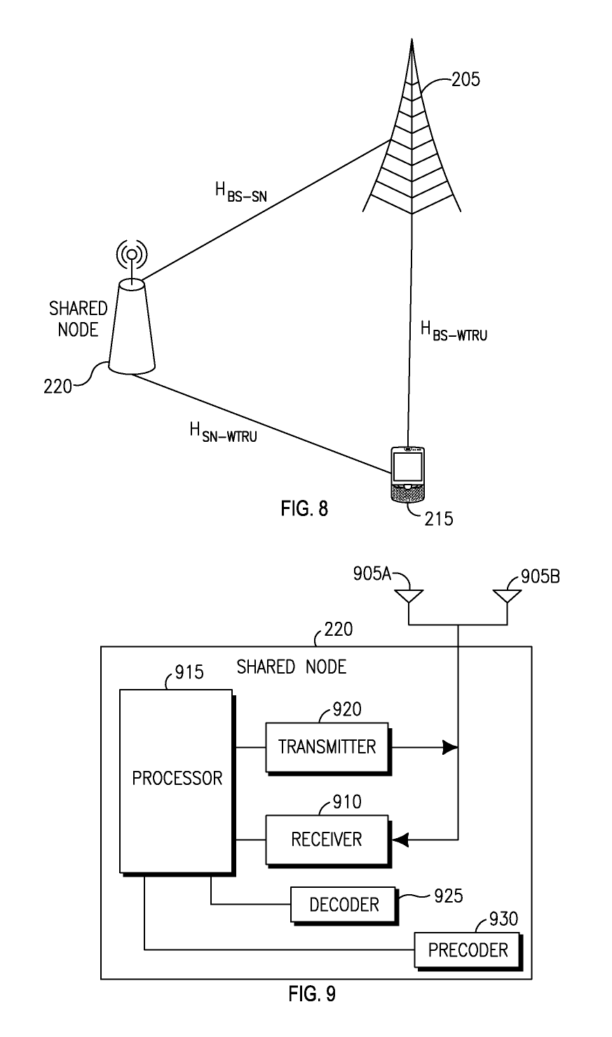

FIG. 8 shows a network in which channel state information (CSI) is defined. The SN 220 needs to know the CSI between all pairs of nodes, (e.g., WTRUs 215). In addition to this, in the partial DF scheme, the BS 205 may require CSI between all pairs of nodes. The WTRU 215 may measure the CSI between itself and the BS 205 (H_{BS-WTRU}) and the SN 220 (H_{SN-WTRU}) separately by using the reference signals, and feedbacks the output to the corresponding BS 205. The SN 220 may measure the CSI between itself and the BS 205 (H_{BS-SN}) by using the reference signals and feedbacks the output to the base station. The SN 220 may need to know the CSI between the WTRU 215 and the BS 205 (H_{BS-WTRU}) to compute the precoding matrices. This information may be transmitted to the SN 220 by the BS 205, (e.g., over a physical downlink control channel (PDCCH) with a specific downlink control information (DCI) format). The SN 220 may receive and decode the uplink control channel of the WTRU 215, which carries the CSI information to the BS 205. This may require that the SN 220 knows the resource allocation of the uplink control channel of the WTRU 215 so that it can read the correct resources that carry the required CSI information. The resource allocation information, (i.e., what information is carried in which resources of the control channel), may be configured by the BS 205 during the initial connection setup.

In the decode and forward scheme, the BS 205 may need to know the CSI between the WTRU 215 and the SN 220 (H_{SN-WTRU}). This may be achieved by the SN 220 transmitting this information in the uplink control channel together with H_{BS-SN}. The BS 205 may receive and decode the uplink control channel of the WTRU 215 that carries the CSI information to the SN 220. This may require that the BS 205 know the resource allocation of the uplink control channel of the WTRU 215 so that it may read the correct resources that carry the required CSI information. The resource allocation information, (i.e., what information is carried in which resources of the control channel), may be configured by the BS 205 during the initial connection setup.

As shown in FIGS. 4 and 5, the WTRUs 215 may provide ACK/NACK feedback to the BSs 205. On the other hand, depending on the successful decoding of the BS 205 signals by the SN 220, the SN 220 may transmit additional information utilizing a Uu connection, as shown in FIG. 5. For example, two bits may be used to indicate to the WTRUs 215 the decoding conditions at the SN 220 as follows:

00: the SN 220 is not able to decode both of BS signals; AF transmission is performed;

01: the SN 220 is not able to decode a first BS signal, but a second BS signal is decoded successfully and the SN 220 transmits the second BS signal only;

10: the SN 220 is not able to decode the second BS signal, but the first BS signal is decoded successfully and the SN 220 transmits the first BS signal only; and

11: the SN 220 is able to decode the BS signals and a precoding procedure may be employed.

FIG. 9 shows an example block diagram of the SN 220 including a plurality of antennas 905A and 905B, a receiver 910, a processor 915, a transmitter 920, a decoder 925 and a precoder 930. The processor 915 may be configured to communicate with and control the receiver 910, the transmitter 920, the decoder 925 and the precoder 930.

The receiver 910 may be configured to receive a first signal including a first codeword and a second signal including a second codeword via the plurality of antennas 905A and 905B. The decoder 925 may be configured to attempt to decode the first and second codewords during a particular TTI.

Alternatively, the receiver 910 may be configured to receive a first signal including a first set of codeword components and a second signal including a second set of codeword components via the plurality of antennas 905A and 905B. The decoder 925 may be configured to attempt to decode at least one codeword component in each of the first and second sets of codeword components during a particular TTI.

The precoder 930 may be configured to precode the first and second signals. The transmitter 920 may be configured to transmit the precoded signals via the plurality of antennas 905A and 905B during a subsequent TTI. The first signal may be transmitted by a first base station in a first cell, and the second signal may be transmitted by a second base station in a second cell.

The receiver 910 may be further configured to receive a list of WTRUs from base stations that transmitted the first and second signals, and to receive channel measurements performed by a plurality of WTRUs on the list. The processor 915 may be configured to select a pair of WTRUs from the list based on the channel measurements. The transmitter may be further configured to transmit information associated with the selected WTRU pair to the selected pair of WTRUs and to base stations that transmitted the first and second signals.

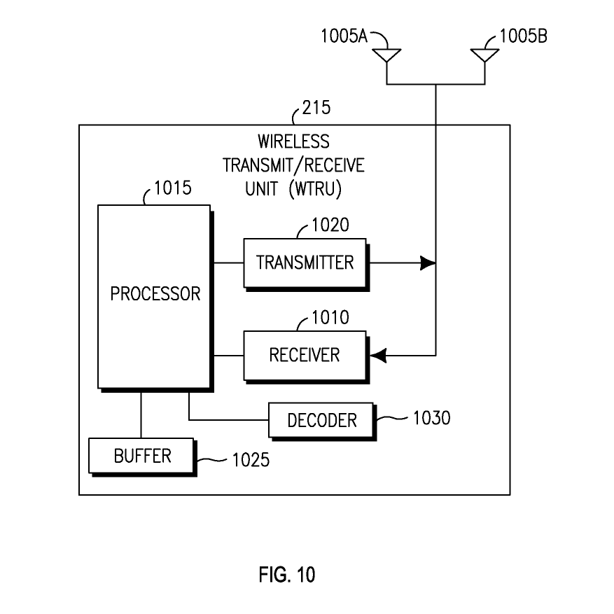

FIG. 10 shows an example block diagram of the WTRU 215 including a plurality of antennas 1005A and 1005B, a receiver 1010, a processor 1015, a transmitter 1020, a buffer 1025 and a decoder 1030. The processor 1015 may be configured to communicate with and control the receiver 1010, the transmitter 1020, the buffer 1025 and the decoder 1030.

The receiver 1010 may be configured to receive a desired signal, an interfering signal and a precoded signal via the plurality of antennas 1005A and 1005B. The buffer 1025 may be configured to buffer the desired and interfering signals. The processor may be further configured to combine the buffered signals with the precoded signal to minimize the interfering signal's power and maximize the desired signal's power at the WTRU 215.

The precoded signal may be generated by the SN 220 based on a first signal transmitted by a first base station in a first cell and a second signal transmitted by a second base station in a second cell.

The first base station may transmit the desired signal and the second base station may transmit the interfering signal in the same resource blocks.

The precoded signal may be generated by an SN 220 that receives and processes the first and second signals during a particular transmission time interval (TTI) and, during a subsequent TTI, the SN 220 may precode the first and second signals, and transmit the precoded signals.

The first signal and the desired signal may include a first codeword, the second signal and the interfering signal may include a second codeword, and the SN 220 may attempt to decode the first and second codewords during the particular TTI.

The decoder 1030 may be configured to attempt to decode the first codeword. The transmitter 1020 may be configured to transmit ACK/NACK feedback to the first base station.

The first signal and the desired signal may include a first set of codeword components, the second signal and the interfering signal may include a second set of codeword components, and the SN 220 may attempt to decode at least one codeword component in each of the first and second sets of codeword components.

The decoder 1030 may be configured to attempt to decode the first set of codeword components. The transmitter 1020 may configured to transmit ACK/NACK feedback for the first set of codeword components to the first base station.

Although features and elements are described above in particular combinations, one of ordinary skill in the art will appreciate that each feature or element may be used alone or in combination with any of the other features and elements. In addition, the embodiments described herein may be implemented in a computer program, software, or firmware incorporated in a computer-readable medium for execution by a computer or processor. Examples of computer-readable media include electronic signals, (transmitted over wired or wireless connections), and computer-readable storage media. Examples of computer-readable storage media include, but are not limited to, a read only memory (ROM), a random access memory (RAM), a register, a cache memory, a semiconductor memory device, a magnetic media, (e.g., an internal hard disc or a removable disc), a magneto-optical media, and an optical media such as a compact disc (CD) or a digital versatile disc (DVD). A processor in association with software may be used to implement a radio frequency transceiver for use in a WTRU, UE, terminal, base station, Node-B, eNB, HNB, HeNB, AP, RNC, wireless router or any host computer.

1. A method of a wireless transmit/receive unit (WTRU) minimizing interference, the method comprising:
receiving a desired signal from a first base station and an interfering signal from a second base station;
buffering the desired and interfering signals;
receiving a signal transmitted by a shared node, wherein the transmitted signal is generated based on a first signal transmitted by the first base station in a first cell and a second signal transmitted by the second base station in a second cell, the first signal including a first codeword, and the second signal including a second codeword; and
combining the buffered signals with the signal transmitted by the shared node to minimize the interfering signal's power and maximize the desired signal's power at the WTRU.

2. The method of claim 1 further comprising:
the first base station transmitting resource usage information to the second base station;
the first base station transmitting the desired signal using time and frequency resources indicated by the resource usage information; and
the second base station transmitting the interfering signal using the same time and frequency resources as the first base station.

3. The method of claim 1 wherein the shared node receives and processes the first and second signals during a particular transmission time interval (TTI) and, during a subsequent TTI, the shared node precodes the first and second signals, and transmits the precoded signals.

4. The method of claim 3 wherein the shared node attempts to decode the first and second codewords during the particular TTI.

5. The method of claim 4 further comprising:
the WTRU attempting to decode the first codeword and sending positive acknowledgement (ACK)/negative acknowledgement (NACK) feedback for the first codeword to the first base station, wherein the first base station is configured to schedule the WTRU; and
a different WTRU attempting to decode the second codeword and sending ACK/NACK feedback for the second codeword to the second base station, wherein the second base station is configured to schedule the different WTRU.

6. The method of claim 3 wherein the first signal and the desired signal include a first set of codeword components, the second signal and the interfering signal include a second set of codeword components, and the shared node attempts to decode at least one codeword component in each of the first and second sets of codeword components.

7. The method of claim 6 further comprising:
the WTRU attempting to decode the first set of codeword components and sending positive acknowledgement (ACK)/negative acknowledgement (NACK) feedback for the first set of codeword components to the first base station, wherein the first base station is configured to schedule the WTRU; and
the different WTRU attempting to decode the second set of codeword components and sending ACK/NACK feedback for the second set of codeword components to the second base station, wherein the second base station is configured to schedule the different WTRU.

8. A wireless transmit/receive unit (WTRU) comprising:
a plurality of antennas;
a receiver configured to receive, via the plurality of antennas, a desired signal from a first base station, an interfering signal from a second base station, and a signal transmitted by a shared node, wherein the transmitted signal is generated based on a first signal transmitted by the first base station in a first cell and a second signal transmitted by the second base station in a second cell, the first signal including a first codeword, and the second signal including a second codeword;
a buffer configured to buffer the desired and interfering signals; and
a processor configured to combine the buffered signals with the signal transmitted by the shared node to minimize the interfering signal's power and maximize the desired signal's power at the WTRU.

9. The WTRU of claim 8 wherein the first base station transmits the desired signal and the second base station transmits the interfering signal in the same resource blocks.

10. The WTRU of claim 8 wherein the shared node receives and processes the first and second signals during a particular transmission time interval (TTI) and, during a subsequent TTI, the shared node precodes the first and second signals, and transmits the precoded signals.

11. The WTRU of claim 10 wherein the shared node attempts to decode the first and second codewords during the particular TTI.

12. The WTRU of claim 11 further comprising:
a decoder configured to attempt to decode the first codeword; and
a transmitter configured to transmit positive acknowledgement (ACK)/negative acknowledgement (NACK) feedback to the first base station.

13. The WTRU of claim 10 wherein the first signal and the desired signal include a first set of codeword components, the second signal and the interfering signal include a second set of codeword components, and the shared node attempts to decode at least one codeword component in each of the first and second sets of codeword components.

14. The WTRU of claim 13 further comprising:
a decoder configured to attempt to decode the first set of codeword components; and
a transmitter configured to transmit positive acknowledgement (ACK)/negative acknowledgement (NACK) feedback to the first base station.
